(19) United States
(12) Patent Application Publication
(10) Pub. No.: US 2012/0297750 A1
(43) Pub. Date: Nov. 29, 2012

(54) METHOD FOR MONITORING AN EXHAUST PARTICULATE FILTER

(75) Inventor: Min Sun, Troy, MI (US)

(73) Assignee: GM GLOBAL TECHNOLOGY OPERATIONS LLC, DETROIT, MI (US)

(21) Appl. No.: 13/115,911

(22) Filed: May 25, 2011

(51) Int. Cl. F01N 3/18; G01M 15/10

(52) U.S. Cl. 60/274; 73/23.33

(57) ABSTRACT

An exhaust aftertreatment system having a particulate filter is monitored by monitoring a particulate filter regeneration event and detecting an associated regeneration period. The particulate filter regeneration period is compared to a preferred event window. A fault is detected when the monitored particulate filter regeneration period extends beyond the preferred event window.

### TECHNICAL FIELD

This disclosure is related to exhaust aftertreatment systems.

### BACKGROUND

The statements in this section merely provide background information related to the present disclosure. Accordingly, such statements are not intended to constitute an admission of prior art.

Known aftertreatment systems for managing and treating an exhaust gas feedstream include a particulate filter device that removes particulate matter, e.g., elemental carbon particles from the feedstream. Known applications for a particulate filter device include internal combustion engines operating lean of stoichiometry, including, e.g., compression-ignition (diesel) engines and lean-burn spark-ignition engines. Known particulate filter devices can experience faults in-service that affect ability of the device to remove particulate matter from the exhaust gas feedstream. Therefore, a need exists for a method of determining in-service faults of such particulate filter devices.

### SUMMARY

An exhaust aftertreatment system having a particulate filter is monitored by monitoring a particulate filter regeneration event and detecting an associated regeneration period. The particulate filter regeneration period is compared to a preferred event window. A fault is detected when the monitored particulate filter regeneration period extends beyond the preferred event window.

### BRIEF DESCRIPTION OF THE DRAWINGS

One or more embodiments will now be described, by way of example, with reference to the accompanying drawings, in which:

FIG. 1 illustrates an exhaust aftertreatment system and an accompanying control system including control module that has been constructed in accordance with an embodiment of the disclosure;

FIG. 2 illustrates details of an embodiment of the particulate filter configured to remove particulate matter from the exhaust gas feedstream, in accordance with the present disclosure; and

FIG. 3 is a flow diagram of the control scheme for monitoring the particulate filter and detecting a fault associated therewith during ongoing operation of the engine in accordance with the present disclosure.

### DETAILED DESCRIPTION

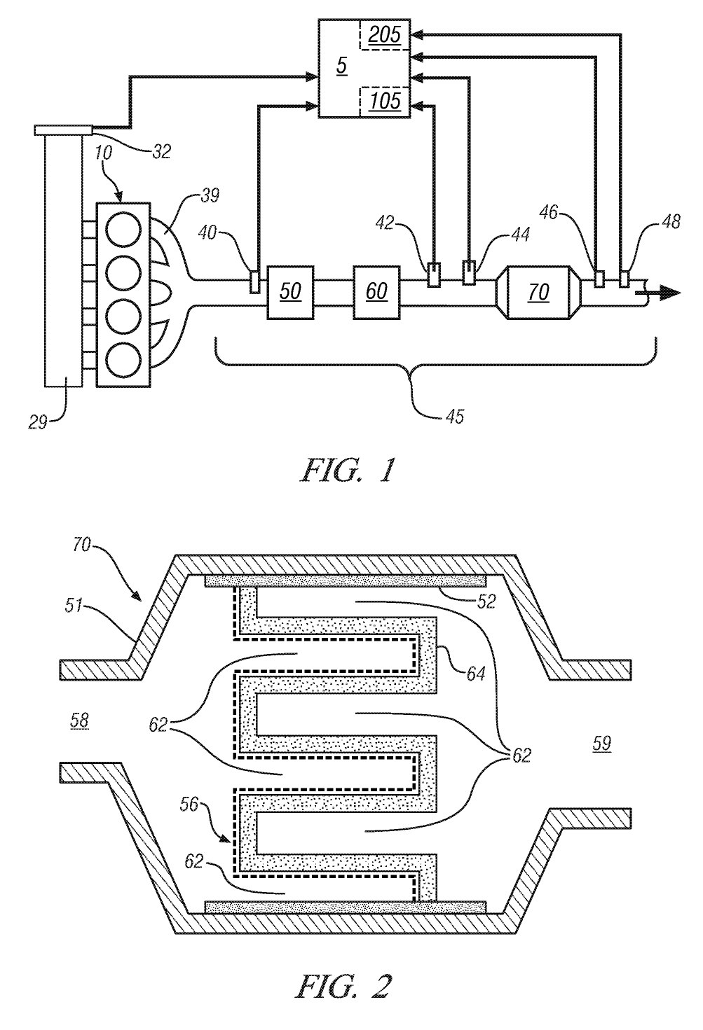

Referring now to the drawings, wherein the showings are for the purpose of illustrating certain exemplary embodiments only and not for the purpose of limiting the same, FIG. 1 schematically illustrates an engine 10 and exhaust aftertreatment system 45 and an accompanying control system including control module 5 that has been constructed in accordance with an embodiment of the disclosure. The exhaust aftertreatment system 45 is fluidly coupled to an exhaust manifold 39 of the internal combustion engine 10 in one embodiment, although the methods described herein are not so limited.

In one embodiment, the engine 10 includes a multi-cylinder direct-injection four-stroke internal combustion engine that is operative lean of a stoichiometric air-fuel ratio to generate mechanical power that can be transmitted to a driveline. An air intake system channels intake air to an intake manifold 29 which directs and distributes the air into intake passages to each combustion chamber of the engine 10. The air intake system includes air flow ductwork and devices for monitoring and controlling the engine intake air flow. The devices preferably include a mass air flow sensor 32 for monitoring mass air flow through the engine 10 and intake air temperature. Other engine control devices include, e.g., a throttle valve can control air flow to the engine 10. The exhaust manifold 39 channels the exhaust gas feedstream from the engine 10 to the exhaust aftertreatment system 45.

The exhaust aftertreatment system 45 includes at least one particulate filter 70 configured to remove particulate matter from the exhaust gas feedstream. In one embodiment, there is a first aftertreatment device 50 upstream of a second aftertreatment device 60. The particulate filter 70 is a third aftertreatment device placed downstream of the first and second aftertreatment devices 50 and 60. In one embodiment, the first aftertreatment device 50 includes an oxidation catalyst and the second aftertreatment device 60 includes a selective catalyst reduction device. The aftertreatment devices 50, 60, and 70 are fluidly connected as a part of the exhaust system 45 to entrain and treat engine exhaust.

The exhaust aftertreatment system 45 is equipped with a plurality of sensing device(s) to monitor the exhaust gas feedstream. The sensing devices preferably include a wide-range air-fuel ratio sensor 40 operative to monitor the exhaust gas feedstream output from the engine 10. A first temperature sensor 42 monitors temperature of the exhaust gas feedstream upstream of the particulate filter 70. A first pressure sensor 44 monitors pressure of the exhaust gas feedstream upstream of the particulate filter 70. A second pressure sensor 46 monitors pressure of the exhaust gas feedstream downstream of the particulate filter 70. A second temperature sensor 48 monitors temperature of the exhaust gas feedstream downstream of the particulate filter 70. Signal outputs of the sensing device(s) are monitored by the control module 5. The first and second temperature sensors 42 and 48 and the first and second pressure sensors 44 and 46 are shown as individual components in one embodiment, but the disclosure is not so limited. Furthermore, the first and second pressure sensors 44 and 46 can be replaced with a differential pressure sensing system comprising a single sensor (not shown) that is operative to monitor a pressure differential between an inlet and an outlet of the particulate filter 70 and operative to monitor inlet pressure to the particulate filter 70. The first pressure sensor 44 may be a manifold absolute pressure sensor. The second pressure sensor 46 may be eliminated in one embodiment.

The control system includes a set of control algorithms executed in the control module 5 including control scheme 105 to monitor the particulate filter 70 and soot loading model 205, which will be discussed in further detail below. The control module 5 may take any suitable form including various combinations of one or more Application Specific Integrated Circuit(s) (ASIC), electronic circuit(s), central processing unit(s) (preferably microprocessor(s)) and associated memory and storage (read only, programmable read only, random access, hard drive, etc.) executing one or more software or firmware programs, combinational logic circuit(s), input/output circuit(s) and devices, appropriate signal conditioning and buffer circuitry, and other suitable components to provide the described functionality. The control module has a set of control algorithms, including resident software program instructions and calibrations stored in memory and executed to provide the desired functions. The algorithms are preferably executed during preset loop cycles. Algorithms are executed, such as by a central processing unit, and are operable to monitor inputs from sensing devices and other networked control modules, and execute control and diagnostic routines to control operation of actuators. Loop cycles may be executed at regular intervals, for example each 3.125, 6.25, 12.5, 25 and 100 milliseconds during ongoing engine and vehicle operation. Alternatively, algorithms may be executed in response to occurrence of an event. The control system can be further capable to control operation of the engine 10 in one embodiment, including controlling operation at a preferred air-fuel ratio to achieve performance parameters related to operator requests, fuel consumption, emissions, and driveability, with the intake air flow controlled to achieve the preferred air-fuel ratio. Engine control can include periodically controlling engine operation to regenerate the particulate filter 70. The control module 5 is also signally connected to an operator interface for communicating with the operator.

FIG. 2 schematically shows details of an embodiment of the particulate filter 70 configured to remove particulate matter from the exhaust gas feedstream. The particulate filter 70 includes a metallic housing 51 having an inlet 58 and an outlet 59 that provides a structural housing for a substrate 64 disposed intermediate the inlet 58 and outlet 59. The inlet 58 fluidly connects to an outlet of the second aftertreatment device 60. The outlet 59 fluidly connects to the remainder of the exhaust system. Insulative support material 52 wraps around the substrate 64 and mechanically supports and secures the substrate 64 within the metallic housing 51. The insulative support material 52 also provides a sealing function to ensure that the exhaust gas feedstream flows through the substrate 64 from the inlet 58 to the outlet 59. The substrate 64 may be coated with a washcoat material 56, shown as applied on the inlet side of the substrate 64 in one embodiment. Preferred washcoat materials can include either an alumina-based washcoat or a zirconium-based washcoat and may include catalytic metals, e.g., platinum, palladium, rhodium, and cerium.

The substrate 64 preferably has a honeycomb structure formed from extruded cordierite with a multiplicity of parallel flow passages 62 formed parallel to an axis between the inlet 58 and the outlet 59. Walls of the substrate 64 formed between the flow passages 62 by the extruded cordierite are porous. Each of the flow passages 62 is preferably closed at one end. Preferably, adjacent flow passages 62 are alternately closed at opposing inlet 58 and outlet 59. The alternately closed flow passages 62 cause the exhaust gas feedstream to flow through the porous walls of the substrate 64 as exhaust gas flows from the inlet 58 to the outlet 59 due to the pressure differential in the exhaust gas feedstream between the inlet 58 and the outlet 59 during engine operation. Flow of the exhaust gas feedstream through the porous walls of the substrate 64 serves to filter or strip particulate matter out of the exhaust gas feedstream and bring the exhaust gas feedstream in close proximity to the washcoat. Alternatively other filtering substrates including foams can be used in place of the substrate 64 having the wall-flow design described herein.

The control system monitors engine operation, the exhaust gas feedstream and the particulate filter 70 to monitor soot generation and detect when regeneration of the particulate filter 70 is necessary. Regeneration is a process by which particulate matter captured by the particulate filter 70 is removed. A known strategy for particulate filter regeneration include burning the trapped particulate matter in the particulate filter 70 by increasing temperatures in the exhaust gas feedstream using, for example, modified air/fuel ratio control schemes, oxidation catalysts, and/or heating elements. The control module 5 executes commands to regenerate the particulate filter 70 using predetermined criteria associated with parameters that indicate soot generation. Parameters that indicate soot generation include, e.g., engine run time, distance traveled, cumulative engine load, fuel consumption, exhaust pressure and pressure change, and other criteria. A soot generation simulation model can be executed using one or more of the parameters that indicate soot generation.

In one embodiment, the control module 5 monitors the soot generation parameters and executes the soot loading model 205 to determine an amount of particulate matter that is collected in or removed from the particulate filter 70. The control module 5 uses the soot loading model 205 to determine when a regeneration event is required. The soot loading model 205 includes an upper soot loading threshold and a lower soot loading threshold. The upper soot loading threshold defines a soot loading point above which a regeneration event is commanded to start based upon soot loading characteristics, i.e., soot generation and soot collection or removed. The lower soot loading threshold defines a soot loading point above which a regeneration event is commanded to terminate based upon soot loading characteristics, i.e., soot generation and soot collection or removed. Additional details respecting soot loading modeling can be found in commonly owned and co-pending U.S. application Ser. No. 13/______, (Attorney Docket No. P009779-RD-MJL), the contents of which are incorporated herein by reference. When a regeneration event begins at or below the upper soot loading threshold an error can be identified. When a regeneration event is terminated at or below the lower soot loading threshold an error can be identified. Therefore the preferred event window includes starting a regeneration event when the soot loading is above the upper soot loading threshold and terminating the regeneration event when the soot loading is above the lower soot loading threshold.

Both the upper soot loading threshold and the lower soot loading threshold may be determined from experimental data for a particular application or may be determined during ongoing operation using the soot loading model 205. Alternatively, the control module 5 uses the predetermined criteria associated with the parameters that indicate soot generation to identify a need to regenerate the particulate filter 70. This may include monitoring flow restriction in the exhaust gas feedstream and detecting when the flow restriction has increased above a threshold indicating a need to regenerate of the particulate filter 70. If a soot loading model 205 is used, it can indicate a need to regenerate the particulate filter 70 and provide a preferred elapsed time for a regeneration event, including when to terminate the regeneration event. The control module 5 sends a command to start the regeneration event and sets a timed response to terminate the regeneration event.

The frequency of regeneration events and the elapsed times for the regeneration events are monitored to evaluate performance of the particulate filter 70. Frequently occurring regeneration events or lengthy elapsed times for regeneration events may indicate a fault associated with the particulate filter 70. Faults associated with the particulate filter 70 can include, e.g., fracturing of the particulate filter substrate, presence of obstructions, and engine control faults, e.g., those associated with fuel metering and EGR valve operation. However, frequent regeneration events may be associated with engine operating conditions, e.g., running the engine 10 at a high load over extended periods of time, and may be appropriate. A monitoring control scheme can be implemented to distinguish between a fault and appropriate regeneration events.

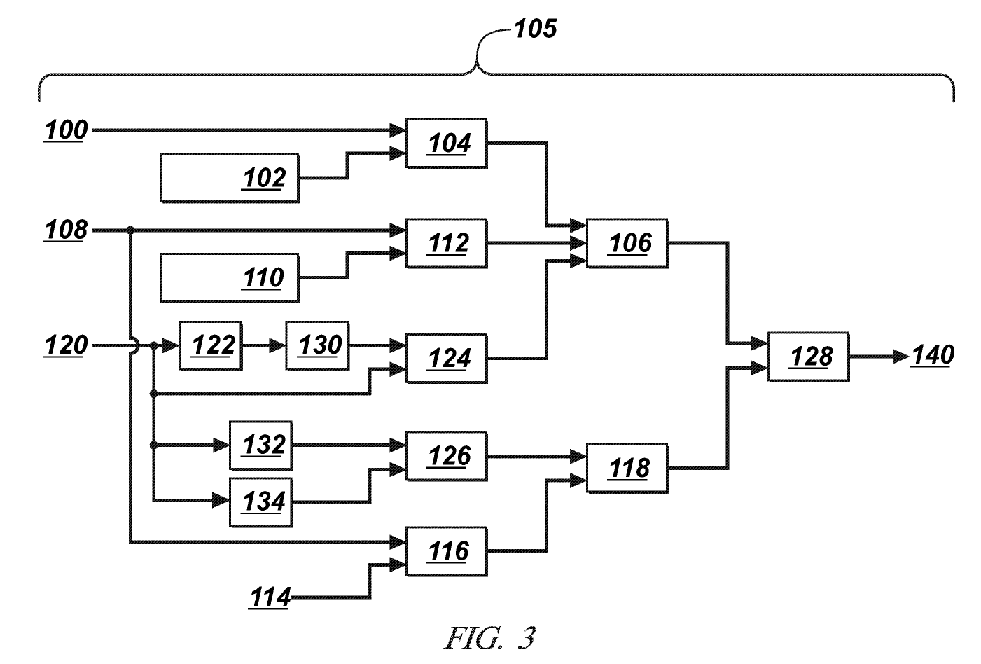

FIG. 3 is a flow diagram of control scheme 105 for monitoring the particulate filter 70 and detecting a fault associated therewith during ongoing operation of the engine 10. The control scheme 105 distinguishes between a fault associated with the particulate filter 70 and appropriate operational regeneration events. The control scheme 105 is configured as executable code residing in the control module 5 wherein the control module 5 monitors an elapsed time from the end of the last regeneration event 100, start time of the current regeneration event, stop time of the current regeneration event, and the quantity of regeneration events. The control scheme 105 sets regeneration markers that identify the beginning, i.e., the start time, and the ending, i.e., the stop time, of the occurrence of each regeneration event. A regeneration interval is defined as an elapsed time period of engine operation from an ending of an immediately previous regeneration event to a beginning of a present regeneration event. A regeneration period is defined as an elapsed time of a regeneration event from start to stop. A cycle is defined as the elapsed time to complete a regeneration interval and a regeneration event. The control scheme 105 can compare the regeneration markers and the elapsed times to the preferred event window for a regeneration interval, period, and cycle to distinguish between faults associated with the particulate filter 70 and appropriate operational regeneration events.

An elapsed time from the end of the last regeneration event 100 is monitored and compared to a maximum regeneration interval 102 at comparator 104. If the comparator 104 determines the maximum regeneration interval 102 is not exceeded by the elapsed time from the end of the last regeneration event 100, an identifying flag is sent to comparator 106 to indicate the regeneration event has started prior to the maximum regeneration interval 102. If the maximum regeneration interval 102 is equaled or exceeded by the time from the last regeneration event 100, the comparator 104 continues checking each regeneration event to determine if an identifying flag should be sent while the output for the comparator 104 is low.

The soot loading model 205 is executed in the control module 5 to determine current particulate filter soot loading 108 as determined from the operating conditions at the engine 10. The particulate filter soot loading 108 is compared to an upper soot loading threshold 110 at comparator 112. If the particulate filter soot loading 108 is less than or equal to the upper soot loading threshold 110 at the start of a regeneration event, an identifying flag is sent to comparator 106 to indicate the regeneration event has begun prematurely. If the particulate filter soot loading 108 exceeds the regeneration start time based on the upper soot loading threshold 110 at the start of a regeneration event, the comparator 112 continues checking each event to determine if an identifying flag should be sent while the output for the comparator 112 is low. The particulate filter soot loading 108 is also compared to the lower soot loading threshold 114 at comparator 116 at the end of a regeneration event. If the particulate filter soot loading 108 is less than or equal to the lower soot loading threshold 114, an identifying flag is sent to comparator 118 to indicate the regeneration event has exceeded a commanded duration. If the particulate filter soot loading 108 is higher than the lower soot loading threshold 114, the comparator 118 continues checking each regeneration event to determine when the regeneration event exceeds the commanded duration while the output for the comparator 118 is low.

The regeneration marker 120 is set to either on or off for every loop cycle to represent active regeneration being on or off during that loop cycle respectively. A last event regeneration marker 122 is flipped at reversal box 130, e.g., if the regeneration marker 120 indicates regeneration is on, the reversal box marker 130 will switch the signal to show regeneration is off. The regeneration marker 120 is compared to the reversal box marker 130 by comparator 124 every loop cycle. If the reversal box marker 130 is on and the regeneration marker 120 is on, the comparator 124 identifies the start of regeneration and sends an identifying flag to comparator 106 to indicate a delay in the start of the regeneration event. If any other combination occurs, the comparator 124 continues checking each loop cycle to determine the occurrence of the start of regeneration while the output for the comparator 124 is low.

The regeneration marker 120 is flipped at reversal box 134, e.g., if the regeneration marker 120 indicates regeneration is on, the reversal box marker 134 will switch the signal to show regeneration is off. The last cycle regeneration marker 132 is compared to the reversal box marker 134 at comparator 126. If the last cycle regeneration marker 132 and the reversal box marker 134 are both registering on, the comparator 126 identifies the regeneration event is continuing past the regeneration event end. The comparator 126 then sends an identifying flag to comparator 118 to indicate the extended running of the regeneration event. If any other combination occurs, the comparator 126 continues to monitor the outputs of the last cycle regeneration marker 132 and the reversal box marker 134 each loop cycle to determine if the regeneration event is continuing past the commanded regeneration event while the output for the comparator 126 is low.

Comparator 106 monitors the outputs from comparators 104, 112, and 124 to identify when each comparator 104, 112, and 124 has sent respective identifying flags. When all three comparators 104, 112, and 124 have sent identifying flags to comparator 106, the output of 106 indicates a regeneration event that is too short is recognized and an identifying flag is sent to comparator 128. If one of the three comparators 104, 112, and 124 have not sent a flag, comparator 106 continues to monitor the outputs of the three comparators 104, 112, and 124 each loop cycle to determine when each one has sent identifying flags.

Comparator 118 monitors the outputs from comparators 116 and 126. When both comparators 116 and 126 have sent identifying flags to comparator 118, a regeneration event that is too long is recognized and an identifying flag is sent to comparator 128. If one of the two comparators 116 and 126 does not send a flag, comparator 118 continues to monitor outputs of the two comparators 116 and 128 each loop cycle and the output for the comparator 118 is low.

Comparator 128 monitors the outputs from comparators 106 and 118. When either of comparator 106 or comparator 118 has sent an identifying flag to comparator 128, an operational fault, i.e., a regeneration event that is too long or too short, is determined to have occurred during regeneration of the particulate filter 70. A warning system command 140 is sent to the control module 5 to notify an operator that the operational fault has occurred. The warning system preferably has an optical warning device for informing an operator that a fault was detected. It should be further noted that the warning signal may also activate additional systems or restrict additional systems as determined by the control module 5. For example, the control module 5 can create an audible signal or restrict an amount of torque generated by the engine 10.

The disclosure has described certain preferred embodiments and modifications thereto. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. Method for monitoring a particulate filter, comprising:
monitoring a particulate filter regeneration event and determining an associated particulate filter regeneration period;
comparing the particulate filter regeneration period to a preferred event window; and
detecting a fault when the determined particulate filter regeneration period falls outside the preferred event window.

2. The method of claim 1, wherein comparing the particulate filter regeneration period to the preferred event window comprises determining the preferred event window from a soot loading model.

3. The method of claim 2, wherein determining the preferred event window from the soot loading model comprises determining an upper soot loading threshold and a lower soot loading threshold.

4. The method of claim 1, wherein detecting the fault when the determined particulate filter regeneration period falls outside the preferred event window comprises determining that the particulate filter regeneration period is less than commanded.

5. The method of claim 1, wherein detecting the fault when the determined period of the particulate filter regeneration event falls outside the preferred event window comprises determining that the particulate filter regeneration period is greater than commanded.

6. The method of claim 1, wherein detecting the fault when the determined period of the particulate filter regeneration event falls outside the preferred event window comprises detecting (i) an abbreviated interval from the last regeneration cycle, (ii) that a soot loading of the particulate filter is less than a regeneration model upper soot loading threshold, and (iii) that the particulate filter regeneration event is initiated prematurely.

7. The method of claim 1, wherein detecting the fault when the determined period of the particulate filter regeneration event falls outside the preferred event window comprises detecting that the particulate filter regeneration event exceeds a time period associated with a lower soot loading threshold.

8. The method of claim 1, wherein detecting the fault when the determined period of the particulate filter regeneration event falls outside the preferred event window is determined when (i) a particulate filter regeneration cycle exceeds a preferred cycle window, and (ii) the particulate filter regeneration cycle exceeds a lower soot loading threshold.

9. The method of claim 1, wherein detecting the fault when the determined period of the particulate filter regeneration event falls outside the preferred event window comprises operating a warning system.

10. The method of claim 9, wherein operating a warning system comprises illuminating an optical warning device.

11. Method for monitoring regeneration of a particulate filter, comprising:
determining a preferred cycle window;
monitoring a particulate filter regeneration cycle;
comparing the particulate filter regeneration cycle to the preferred cycle window; and
detecting a fault when the particulate filter regeneration cycle exceeds the preferred cycle window.

12. The method of claim 11, wherein determining the preferred cycle window comprises determining an upper soot loading threshold and a lower soot loading threshold.

13. The method of claim 12, wherein determining the upper soot loading threshold and the lower soot loading threshold is determined from a soot loading model.

14. The method of claim 11, wherein monitoring the particulate filter regeneration cycle comprises marking a beginning and an ending of a filter regeneration cycle with a regeneration marker.

15. The method of claim 14, wherein monitoring the particulate filter regeneration cycle comprising marking a beginning and an ending of a filter regeneration cycle with a regeneration marker comprises comparing the regeneration marker to the preferred cycle window.

16. The method of claim 11, wherein detecting the fault when the particulate filter regeneration cycle exceeds the preferred cycle window comprises a particulate filter regeneration cycle having an abbreviated particulate filter regeneration cycle.

17. The method of claim 16, wherein detecting the fault when the particulate filter regeneration cycle exceeds the preferred cycle window comprises a particulate filter regeneration cycle having an abbreviated particulate filter regeneration cycle comprises detecting (i) an abbreviated time period from a last regeneration cycle, (ii) a soot generation model failing to meet a upper soot loading threshold, and (iii) that the particulate filter regeneration cycle is initiated prematurely.

18. The method of claim 11, wherein detecting the fault when the particulate filter regeneration cycle exceeds the preferred cycle window comprises a particulate filter regeneration cycle having a protracted particulate filter regeneration duration.

19. The method of claim 18, wherein detecting the fault when the particulate filter regeneration cycle exceeds the preferred cycle window comprises a particulate filter regeneration cycle having a protracted particulate filter regeneration duration comprises detecting a soot loading model exceeding a lower soot loading threshold when regeneration ceases operation.

20. Method for controlling regeneration of a particulate filter, comprising:
commanding a regeneration event;
monitoring an interval and a period associated with the regeneration event; and
detecting a fault when the interval and the period associated with the regeneration event exceeds a preferred cycle window.
